(19) United States
(12) Patent Application Publication
(10) Pub. No.: US 2026/0141556 A1
(43) Pub. Date: May 21, 2026

(54) EYEBALL PARAMETER CHECKING METHOD AND SYSTEM, AND COMPUTER AND READABLE STORAGE MEDIUM

(71) Applicant: NANCHANG VIRTUAL REALITY RESEARCH INSTITUTE CO., LTD., Nanchang, Jiangxi (CN)

(72) Inventors: Yansong GUO, Nanchang (CN); Qimin SUN, Nanchang (CN); Jianjun LI, Nanchang (CN); Zhenmin GUO, Nanchang (CN)

(73) Assignee: NANCHANG VIRTUAL REALITY RESEARCH INSTITUTE CO., LTD., Nanchang, Jiangxi (CN)

(21) Appl. No.: 18/705,754

(22) PCT Filed: Oct. 22, 2022
(86) PCT No.: PCT/CN2022/126850

§ 371 Date: Apr. 29, 2024

(30) Foreign Application Priority Data
Oct. 29, 2021 (CN) 202111276552.1

(51) Int. Cl. G06T 7/73; G06T 7/60

(52) U.S. Cl. CPC G06T 7/74; G06T 7/60

(57) ABSTRACT

The present invention provides an eyeball parameter calibration method and system, a computer, and a readable storage medium. The method includes: obtaining an image parameter of a pupil projection corresponding to an eyeball of a user in a current gaze point scenario, to obtain a to-be-calibrated eyeball parameter; performing coordinate matching on the to-be-calibrated eyeball parameter and preset eyeball data to obtain a target eyeball parameter, where the preset eyeball data includes image parameters of the pupil projection corresponding to the eyeball of the user in different gaze point scenarios; performing consistency check on the to-be-calibrated eyeball parameter based on the target eyeball parameter; and if the consistency check on the to-be-calibrated eyeball parameter is qualified, performing pattern matching on the to-be-calibrated eyeball parameter and the preset eyeball data to obtain an eyeball calibration parameter, and calibrating the to-be-calibrated eyeball parameter based on the eyeball calibration parameter. In this application, a check result of an ellipse parameter can be effectively verified and corrected to avoid errors, thereby improving user experience.

This application claims priority to Chinese Patent Application No. 202111276552.1, filed with the China National Intellectual Property Administration on Oct. 29, 2021 and entitled “EYEBALL PARAMETER CALIBRATION METHOD AND SYSTEM, COMPUTER, AND READABLE STORAGE MEDIUM”, which is incorporated herein by reference in its entirety.

### TECHNICAL FIELD

The present invention pertains to the technical field of data processing, and in particular to an eyeball parameter calibration method and system, a computer, and a readable storage medium.

### BACKGROUND

A virtual reality (English: Virtual Reality, VR for short) technology is a brand-new practical technology developed in the 20th century. The virtual reality technology includes computer, electronic information, and simulation technologies, and its basic implementation is simulating the virtual environment by using a computer to give people a sense of environmental immersion. With the continuous development of social productive forces and science and technology, the demand for the VR technology is increasingly growing in all walks of life. The VR technology has also made great progress and has gradually become a new field of science and technology.

In order to better improve user experience, it is necessary to track eyeballs of a user accurately. Therefore, it is necessary to pre-install an eyeball tracking algorithm in an existing VR device.

In most existing eyeball tracking algorithms, it is assumed that a pupil contour is circular; in addition, when the normal direction of the pupil contour circle is not parallel to the optical axis of a camera, an image of the pupil contour is usually an oblique ellipse; and when the radius of the pupil circle and the center of eyeball rotation are fixed, a range of center positions of all possible oblique ellipses is determined, and a relationship between shape parameters and the center positions of the ellipses is also determined. Therefore, whenever an ellipse of a pupil contour is checked, it is necessary to verify whether a shape parameter and a center position of the ellipse conform to the foregoing relationship. However, in the prior art, a check result of the foregoing ellipse parameters is not verified and corrected. This is prone to errors and is not conducive to improving user experience.

### SUMMARY

Based on this, the present invention is intended to provide an eyeball parameter calibration method and system, a computer, and a readable storage medium, so as to solve the problem that errors are likely to occur due to the lack of verification and correction of ellipse parameter check results in the prior art.

According to a first aspect, some embodiments of this application provide an eyeball parameter calibration method. The method includes: obtaining an image parameter of a pupil projection corresponding to an eyeball of a user in a current gaze point scenario, to obtain a to-be-calibrated eyeball parameter;
performing coordinate matching on the to-be-calibrated eyeball parameter and preset eyeball data to obtain a target eyeball parameter, where the preset eyeball data includes image parameters of the pupil projection corresponding to the eyeball of the user in different gaze point scenarios;
performing consistency check on the to-be-calibrated eyeball parameter based on the target eyeball parameter; and
if the consistency check on the to-be-calibrated eyeball parameter is qualified, performing pattern matching on the to-be-calibrated eyeball parameter and the preset eyeball data to obtain an eyeball calibration parameter, and calibrating the to-be-calibrated eyeball parameter based on the eyeball calibration parameter.

The present invention has the following beneficial effects: The to-be-calibrated eyeball parameter is obtained by obtaining the image parameter of the pupil projection corresponding to the eyeball of the user, so that a check result of an ellipse corresponding to a pupil of the eyeball of the user can be preliminarily obtained. Further, coordinate matching is performed on the to-be-calibrated eyeball parameter and the preset eyeball data to obtain the corresponding target eyeball parameter in the current gaze point scenario. Then, the consistency check is performed on the to-be-calibrated eyeball parameter and the target eyeball parameter, to check a parameter error between the to-be-calibrated eyeball parameter and the target eyeball parameter. Whether the to-be-calibrated eyeball parameter is a valid parameter can be effectively checked depending on the parameter error. If the consistency check on the to-be-calibrated eyeball parameter is qualified, pattern matching is performed on the to-be-calibrated eyeball parameter and the preset eyeball data to determine the eyeball calibration parameter of the to-be-calibrated eyeball parameter in the preset eyeball data. The to-be-calibrated eyeball parameter is calibrated based on the eyeball calibration parameter, so that the to-be-calibrated eyeball parameter can be effectively corrected, thereby avoiding errors and improving user experience.

In some embodiments of this application, the method further includes:
obtaining image parameters of the pupil projection corresponding to the eyeball of the user in different gaze point scenarios based on a preset eyeball model, to obtain at least one reference eyeball parameter, where the reference eyeball parameter includes an eyeball shape parameter and an eyeball position parameter;
determining a position mapping relationship between a calibrated gaze point and each eyeball position parameter based on gaze point coordinates of the calibrated gaze point and each eyeball position parameter; and
determining a shape mapping relationship based on the eyeball shape parameter and the eyeball position parameter in each reference eyeball parameter.

In some embodiments of this application, the step of performing consistency check on the to-be-calibrated eyeball parameter based on the target eyeball parameter includes:
determining an eyeball shape parameter of the to-be-calibrated eyeball parameter based on the shape mapping relationship;
respectively determining similarities between an eyeball shape parameter and an eyeball position parameter of the target eyeball parameter and those of the to-be-calibrated eyeball parameter to obtain a first similarity and a second similarity; and
if the first similarity and the second similarity are both greater than a corresponding similarity threshold, determining that the consistency check on the to-be-calibrated eyeball parameter is qualified.

In some embodiments of this application, the step of performing consistency check on the to-be-calibrated eyeball parameter based on the target eyeball parameter further includes:
determining a Hausdorff distance between ellipse images corresponding to the target eyeball parameter and the to-be-calibrated eyeball parameter based on the target eyeball parameter and the to-be-calibrated eyeball parameter; and
if the Hausdorff distance is less than a distance threshold, determining that the consistency check on the to-be-calibrated eyeball parameter is qualified.

In some embodiments of this application, the step of performing pattern matching on the to-be-calibrated eyeball parameter and the preset eyeball data to obtain an eyeball calibration parameter includes:
taking center coordinates of the to-be-calibrated eyeball parameter as a center of a circle and specifying a search radius and a search interval to search in the preset eyeball data;
if it is checked that center energy of the reference eyeball parameter is less than that of the to-be-calibrated eyeball parameter, performing coordinate update on the center coordinates of the to-be-calibrated eyeball parameter based on center coordinates of the reference eyeball parameter, where the center energy is a sum of brightness energy, gradient amplitude energy and gradient direction energy of the reference eyeball parameter;
returning, based on center coordinates of the to-be-calibrated eyeball parameter obtained through the coordinate update, to the step of taking center coordinates of the to-be-calibrated eyeball parameter as a center of a circle and specifying a search radius and a search interval to search in the preset eyeball data; and
if an energy variation between the to-be-calibrated eyeball parameter after the coordinate update and the to-be-calibrated eyeball parameter before the coordinate update is less than an energy threshold, determining the to-be-calibrated eyeball parameter after the current coordinate update as the eyeball calibration parameter.

In some embodiments of this application, the step of performing pattern matching on the to-be-calibrated eyeball parameter and the preset eyeball data to obtain an eyeball calibration parameter further includes:
setting an initial value of the to-be-calibrated eyeball parameter, and obtaining a corresponding energy function based on the initial value;
calculating, based on the energy function, a gradient corresponding to center coordinates of the to-be-calibrated eyeball parameter, and calculating a search direction; and
obtaining an optimal step size based on the energy function, and updating the center coordinates of the to-be-calibrated eyeball parameter, to obtain the eyeball calibration parameter.

In some embodiments of this application, after the step of calibrating the to-be-calibrated eyeball parameter based on the eyeball calibration parameter, the method further includes:
determining gaze calibration coordinates of a gaze point in the current gaze point scenario based on the position mapping relationship and the eyeball calibration parameter, and calibrating the gaze point based on the gaze calibration coordinates.

According to a second aspect, an embodiment of this application provides an eyeball parameter calibration system. The system includes:
an obtaining module, configured to obtain an image parameter of a pupil projection corresponding to an eyeball of a user in a current gaze point scenario, to obtain a to-be-calibrated eyeball parameter;
a matching module, configured to perform coordinate matching on the to-be-calibrated eyeball parameter and preset eyeball data to obtain a target eyeball parameter, where the preset eyeball data includes image parameters of the pupil projection corresponding to the eyeball of the user in different gaze point scenarios;
a checking module, configured to perform consistency check on the to-be-calibrated eyeball parameter based on the target eyeball parameter; and
a first calibration module, configured to: if the consistency check on the to-be-calibrated eyeball parameter is qualified, perform pattern matching on the to-be-calibrated eyeball parameter and the preset eyeball data to obtain an eyeball calibration parameter, and calibrate the to-be-calibrated eyeball parameter based on the eyeball calibration parameter.

According to a third aspect, an embodiment of this application provides a computer, including a memory, a processor, and a computer program stored in the memory and capable of being run on the processor, where when the processor executes the computer program, the eyeball parameter calibration method described above is implemented.

According to a fourth aspect, an embodiment of this application provides a readable storage medium storing a computer program, where when the program is executed by a processor, the eyeball parameter calibration method described above is implemented.

Additional aspects and advantages of the present invention will be given in part in the following descriptions, part of which will become apparent in the following descriptions or be learned from the practice of the present invention.

### BRIEF DESCRIPTION OF DRAWINGS

FIG. 1 is a flowchart of an eyeball parameter calibration method according to a first embodiment of the present invention;

FIG. 2 is a flowchart of an eyeball parameter calibration method according to a second embodiment of the present invention;

FIG. 3 is a schematic diagram of preset eyeball data in the eyeball parameter calibration method according to the second embodiment of the present invention;

FIG. 4 is a flowchart of an eyeball parameter calibration method according to a third embodiment of the present invention; and

FIG. 5 is a structural block diagram of an eyeball parameter calibration system according to a fourth embodiment of the present invention.

In the following description of embodiments, the present invention will be further described with reference to the above accompanying drawings.

### DESCRIPTION OF EMBODIMENTS

In order to facilitate the understanding of the present invention, the present invention will be described more comprehensively below with reference to related accompanying drawings. Several embodiments of the present invention are shown in the accompanying drawings. However, the present invention can be embodied in many different forms and is not limited to the embodiments described herein. On the contrary, these embodiments are provided to make the disclosure of the present invention more thorough and comprehensive.

It should be noted that when an element is described as being “fixed to” another element, it may be directly on the another element or there may be an element therebetween. When an element is considered as being “connected to” another element, the element may be directly connected to the another element or there may be an element therebetween. The terms “vertical”, “horizontal”, “left”, “right”, and similar expressions used herein are for illustration only.

Unless otherwise defined, all technical and scientific terms used herein have same meanings as commonly understood by those skilled in the art to which the present invention pertains. The terms used in this specification of the present invention herein are only for the purpose of describing specific embodiments, and are not intended to limit the present invention. The term “and/or” used herein includes any or all combinations of one or more associated listed items.

In most existing eyeball tracking algorithms, it is assumed that a pupil contour is circular; when a sight line of an eyeball is not parallel to the optical axis of a camera, an image of the pupil contour is usually an oblique ellipse; and when the radius of the pupil circle and the center of eyeball rotation are fixed, a range of center positions of all possible oblique ellipses is determined, and a relationship between shape parameters and the center positions of the ellipses is also determined. Therefore, whenever an ellipse of a pupil contour is checked, it is necessary to verify whether a shape parameter and a center position of the ellipse conform to the foregoing relationship. However, in the prior art, a check result of the foregoing ellipse parameters is not verified and corrected. This is prone to errors and is not conducive to improving user experience.

The eyeball parameter calibration method in the present invention can be applied to apparatuses or systems that obtain eyeball parameters through eye images shot by cameras, such as VR devices and head-mounted display (HMD) devices. For VR devices with a gaze point rendering function, verifying and correcting an eyeball parameter can reduce a probability of rendering position errors and improve smoothness of display images.

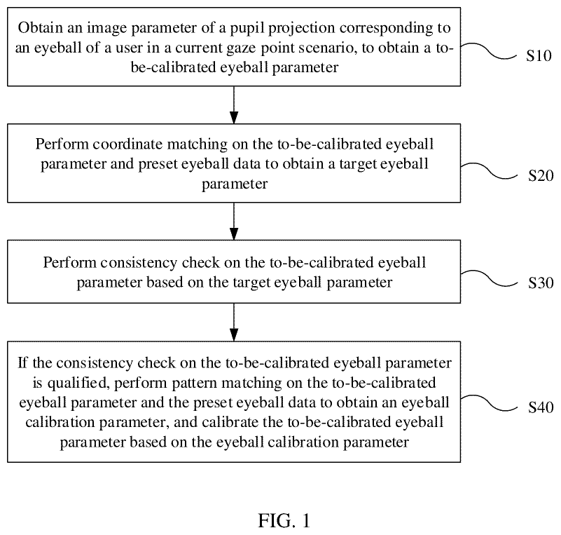

FIG. 1 shows an eyeball parameter calibration method according to a first embodiment of the present invention. Specifically, the eyeball parameter calibration method is mainly used for checking and verifying an ellipse parameter corresponding to an ellipse projected by a pupil of an eyeball of a user. The method specifically includes the following steps.

Step S10: Obtain an image parameter of a pupil projection corresponding to an eyeball of a user in a current gaze point scenario, to obtain a to-be-calibrated eyeball parameter.

The to-be-calibrated eyeball parameter refers to information extracted from a captured image by the user during use of a VR device, that is, an ellipse parameter of a contour of the pupil projection. This image information can be stored in a form of video frames. During use, the user can watch a virtual scene at will. When the user wears the VR device, a position at which a sight line of the user falls on a display screen of the VR device is gaze point coordinates of a gaze point in the current gaze point scenario. The VR device can collect coordinates of gaze points of the user at different positions.

For example, in this step, a video frame obtained by the eyeball of the user is Q1, an image of the pupil projection corresponding to the eyeball of the user in the video frame Q1 is an image A1, a shape corresponding to the image A1 is an ellipse B1, and an image parameter corresponding to the ellipse B1 is the to-be-calibrated eyeball parameter.

Therefore, in this embodiment, first, the image parameter projected by the pupil of the eyeball of the user in the current gaze point scenario is obtained. The gaze point scenario is watched by the user when a gaze point is in different coordinates. The image parameter includes a shape parameter and a position parameter of an ellipse projected by the pupil of the eyeball of the user, so that the to-be-calibrated eyeball parameter that needs to be checked and verified can be obtained.

Step S20: Perform coordinate matching on the to-be-calibrated eyeball parameter and preset eyeball data to obtain a target eyeball parameter.

In this embodiment, in order to quickly complete the coordinate matching of the to-be-calibrated eyeball parameter, the preset eyeball data, to be specific, a plurality of image parameters that may be projected by the pupil of the eyeball of the user in the foregoing different gaze point scenarios, is established in advance, and the preset eyeball data is extracted from the plurality of image parameters. Optionally, several pupil diameters can be set in a preset eyeball model to generate a plurality of groups of reference eyeball parameters. Further, based on eyeball parameters obtained through historical observation in the preset eyeball model, a specific range of pupil diameters can be set to generate corresponding reference eyeball parameters.

Further, when the to-be-calibrated eyeball parameter is obtained in step S10, center coordinates of the to-be-calibrated eyeball parameter can be immediately matched with center coordinates in the preset eyeball data. When similar or consistent center coordinates are obtained through matching, an ellipse parameter corresponding to the center coordinates is the required target eyeball parameter.

The preset eyeball data includes the image parameters of the pupil projection corresponding to the eyeball of the user in the different gaze point scenarios. That is, the preset eyeball data includes shape parameters and position parameters of ellipses projected by the pupil corresponding to the eyeball of the user in cases of different gaze point coordinates. It should be noted that, in the preset eyeball data, the gaze point coordinates are stored in a correspondence with the shape parameters and the position parameters of the ellipses projected by the corresponding pupil.

Optionally, in this embodiment, for the preset eyeball data, the method further includes the following step.

Image parameters of the pupil projection corresponding to the eyeball of the user in different gaze point scenarios are obtained based on a preset camera-eyeball model, so as to obtain at least one reference eyeball parameter, where the reference eyeball parameter includes an eyeball shape parameter and an eyeball position parameter. In this step, the eyeball parameter calibration method is applied to an HMD device. The HMD device first obtains a standard preset eyeball model, and sets center coordinates c, an eyeball radius R and a pupil radius r of the preset eyeball model in a coordinate system.

For example, a camera coordinate system is used as a reference. A rotation matrix of a camera is R_{cam}=I, a translation vector is t_{cam}=[0; 0; 0], and a projection matrix of the camera is K=[f, 0, cx; 0, f, cy; 0, 0, 1]. A position of the eyeball is t_{eye}, and a distance between a pupil center and an eyeball center is ρ. An optical axis direction of the eyeball is dₒ, and a visual axis direction of the eyeball is dᵥ. A starting point of the optical axis direction of the eyeball is the pupil center c, and the optical axis direction is consistent with a normal direction of a pupil circle. A starting point of the visual axis direction of the eyeball is the pupil center, and there is an angle difference κ between the visual axis direction and the optical axis direction of the eyeball. A gaze point is an intersection point of a screen plane and a straight line of a visual axis.

Based on the optical axis direction of the eyeball, coordinates of the pupil center are calculated as c=t_{cam}+dₒ*ρ.

Based on the coordinates of the pupil center and the optical axis direction of the eyeball, coordinates p of a point on a circumference are calculated as follows:

$$p = c + r * cos ( {θ}_{p} ) * u + r * sin ( {θ}_{p} ) * v .$$

θₚ is an angle parameter of the point on the circumference, and u and v are unit vectors that are both perpendicular to the optical axis direction of the eyeball and perpendicular to each other.

Based on the rotation matrix and a translation matrix of the camera, a projection point of p is calculated as q=K*[R_{cam}, t_{cam}]*p. A plurality of qs are fitted into an ellipse as a projection of the pupil circle on the camera.

Further, the plurality of image parameters that may be correspondingly projected by the pupil of the eyeball of the user in the different gaze point scenarios are obtained based on the preset eyeball model, so that at least one standard reference eyeball parameter can be obtained. The reference eyeball parameter includes an eyeball shape parameter and an eyeball position parameter, where the eyeball shape parameter is (a,b,θ), and the eyeball position parameter is (x₀, y₀). Specifically, a is a semi-major axis of the ellipse corresponding to the pupil projection of the eyeball, b is a semi-minor axis of the ellipse corresponding to the pupil projection of the eyeball, and θ is an inclination angle corresponding to a semi-major axis whose absolute angle value with the x-axis is less than or equal to 90 degrees. The eyeball position parameter (x₀, y₀) represents coordinates of a center point of the ellipse corresponding to the pupil projection of the eyeball.

A position mapping relationship between a calibrated gaze point and each eyeball position parameter is determined based on gaze point coordinates of the calibrated gaze point and each eyeball position parameter.

In this step, a one-to-one correspondence between the gaze point coordinates (x_{g}, y_{g}) of the calibrated gaze point and each eyeball position parameter (x₀, y₀) obtained in step S10 is further determined based on the gaze point coordinates and each eyeball position parameter:

$$\{ \begin{matrix}{x}_{g} = {f}_{x} ( {x}_{0} , {y}_{0} ) \\ {y}_{g} = {f}_{y} ( {x}_{0} , {y}_{0} )\end{matrix} .$$

fₓ and f_{y} are binary quadratic polynomials fitted based on a plurality of (x₀, y₀) and (x_{g}, y_{g}) corresponding to them one by one.

A shape mapping relationship is determined based on the eyeball shape parameter and the eyeball position parameter in each reference eyeball parameter.

In this step, the shape mapping relationship in the eyeball parameter is further determined based on the eyeball shape parameter (a, b, θ) and the eyeball position parameter (x₀, y₀) in each reference eyeball parameter, that is:

$$\{ \begin{matrix}a = {f}_{a} ( {x}_{0} , {y}_{0} ) \\ b = {f}_{b} ( {x}_{0} , {y}_{0} ) \\ θ = {f}_{θ} ( {x}_{0} , {y}_{0} )\end{matrix} .$$

In addition, based on an eye model parameter, an ellipse (x₀, y₀, a, b, θ) corresponding to pupil projections at a plurality of positions can be further calculated. fₐ, f_{b}, and f_{θ} are binary quadratic polynomials fitted based on a plurality of (x₀, y₀) and corresponding (a, b, θ) That is, the reference eyeball parameter is expressed as e=(x₀, y₀, a, b, θ)=fₑ(c).

Step S30: Perform consistency check on the to-be-calibrated eyeball parameter based on the target eyeball parameter.

The consistency check is performed on the to-be-calibrated eyeball parameter based on the target eyeball parameter to check a parameter error between the to-be-calibrated eyeball parameter and the target eyeball parameter, and whether the to-be-calibrated eyeball parameter is an effective parameter can be effectively checked based on the parameter error.

Furthermore, when a method based on a general ellipse rule such as Hough transform (Hough transform) or machine learning is used to check the to-be-calibrated eyeball parameter, there may be a deviation in a checked eyeball parameter \tilde{e}=(\tilde{x}₀, \tilde{y}₀, ã, \tilde{b}, \tilde{θ}), especially when an ellipse image corresponding to the to-be-calibrated eyeball parameter is incomplete. The deviation of the to-be-calibrated eyeball parameter will affect calculation of the gaze point coordinates based on the to-be-calibrated eyeball parameter or calculation of an error of a sight line direction based on the to-be-calibrated eyeball parameter. Therefore, in this embodiment, it is necessary to perform consistency check on the to-be-calibrated eyeball parameter to check whether the to-be-calibrated eyeball parameter is valid data.

Specifically, center coordinates, semi-major axes, semi-minor axes, and inclination angles of images of pupil projections corresponding to the target eyeball parameter and the to-be-calibrated eyeball parameter are obtained separately, and consistency between the target eyeball parameter and the to-be-calibrated eyeball parameter is determined by comparing consistency between the center coordinates, the semi-major axes, the semi-minor axes, and the inclination angles of the target eyeball parameter and the to-be-calibrated eyeball parameter separately. Preferably, in this step, a target eyeball vector and a to-be-calibrated eyeball vector are obtained by vectorizing the target eyeball parameter and the to-be-calibrated eyeball parameter respectively, a similarity between the target eyeball vector and the to-be-calibrated eyeball vector is calculated based on an Euclidean distance formula, and whether the consistency check on the to-be-calibrated eyeball parameter is qualified is determined based on the similarity between the target eyeball vector and the to-be-calibrated eyeball vector.

Optionally, in this step, if the consistency check on the to-be-calibrated eyeball parameter is unqualified, that is, the parameter error between the to-be-calibrated eyeball parameter and the target eyeball parameter is greater than an error threshold, it is determined that the target eyeball parameter has a large deviation, and the to-be-calibrated eyeball parameter in the current video frame is marked with an invalid mark. The invalid mark can be marked by words, numbers, or letters, and the invalid mark is for reminding the user that the to-be-calibrated eyeball parameter in the current video frame has a large error. Therefore, the to-be-calibrated eyeball parameter in the current video frame is an invalid parameter.

Step S40: If the consistency check on the to-be-calibrated eyeball parameter is qualified, perform pattern matching on the to-be-calibrated eyeball parameter and the preset eyeball data to obtain an eyeball calibration parameter, and calibrate the to-be-calibrated eyeball parameter based on the eyeball calibration parameter.

The pattern matching is performed on to-be-calibrated eyeball parameter and the preset eyeball data to obtain an eyeball parameter that has a same shape as the to-be-calibrated eyeball parameter in the preset eyeball data, to obtain the eyeball calibration parameter.

Further, when the eyeball calibration parameter is obtained, a corresponding eyeball shape parameter and a corresponding eyeball position parameter in the to-be-calibrated eyeball parameter are replaced with the eyeball shape parameter and the eyeball position parameter in the eyeball calibration parameter, so that the to-be-calibrated eyeball parameter can be calibrated.

It should be noted that the foregoing implementation process is only for illustrating enforceability of this application, but this does not mean that the eyeball parameter calibration method in this application has the only one implementation process described above. On the contrary, any process that can implement the eyeball parameter calibration method in this application can be included in feasible implementations of this application.

In conclusion, in the eyeball parameter calibration method in the foregoing embodiment of the present invention, the to-be-calibrated eyeball parameter is obtained by obtaining the image parameter of the pupil projection corresponding to the eyeball of the user, so that a check result of an ellipse corresponding to a pupil of the eyeball of the user can be preliminarily obtained. Further, coordinate matching is performed on the to-be-calibrated eyeball parameter and the preset eyeball data to obtain the corresponding target eyeball parameter in the current gaze point scenario. Then, the consistency check is performed on the to-be-calibrated eyeball parameter and the target eyeball parameter, to check a parameter error between the to-be-calibrated eyeball parameter and the target eyeball parameter. Whether the to-be-calibrated eyeball parameter is a valid parameter can be effectively checked depending on the parameter error. If the consistency check on the to-be-calibrated eyeball parameter is qualified, it is determined that pattern matching is performed on the to-be-calibrated eyeball parameter and the preset eyeball data to determine the eyeball calibration parameter of the to-be-calibrated eyeball parameter in the preset eyeball data. The to-be-calibrated eyeball parameter is calibrated based on the eyeball calibration parameter, so that the to-be-calibrated eyeball parameter can be effectively corrected, thereby avoiding errors and improving user experience.

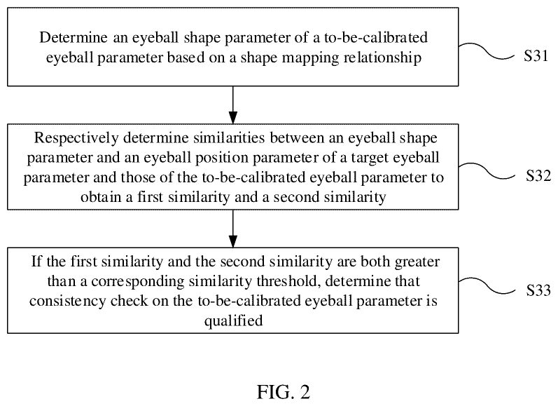

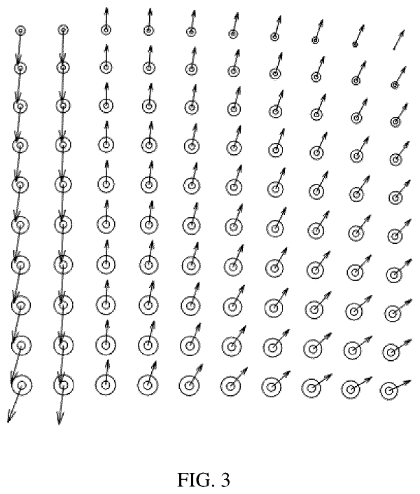

FIG. 2 and FIG. 3 show an eyeball parameter calibration method according to a second embodiment of the present invention. This embodiment is for further detailing step S30 in the embodiment of FIG. 1, including the following steps.

Step S31: Determine the eyeball shape parameter of the to-be-calibrated eyeball parameter based on the shape mapping relationship.

In this step, specifically, the eyeball shape parameter of the to-be-calibrated eyeball parameter is determined based on the shape mapping relationship of the ellipse obtained in step S20.

For example, when the eyeball position parameter of the to-be-calibrated eyeball parameter is (x1, y1), the determined eyeball shape parameter is:

$$( a 1 , b 1 , θ1 ) , where a 1 = {f}_{a} ( x 1 , y 1 ) , b 1 = {f}_{b} ( x 1 , y 1 ) , and θ1 = {f}_{θ} ( x 1 , y 1 ) .$$

Step S32: Respectively determine similarities between the eyeball shape parameter and the eyeball position parameter of the target eyeball parameter and those of the to-be-calibrated eyeball parameter to obtain a first similarity and a second similarity.

Further, in this step, the first similarity corresponding to the eyeball shape parameter and the eyeball position parameter in the target eyeball parameter is determined, and the second similarity corresponding to the eyeball shape parameter and the eyeball position parameter in the to-be-calibrated eyeball parameter is determined.

Step S33: If the first similarity and the second similarity are both greater than a corresponding similarity threshold, determine that the consistency check on the to-be-calibrated eyeball parameter is qualified.

Furthermore, when the first similarity and the second similarity are both greater than the corresponding similarity threshold, that is, the deviation between the target eyeball parameter and the to-be-calibrated eyeball parameter is small, it can be determined that the consistency check on the to-be-calibrated eyeball parameter is qualified.

In this embodiment, it should be noted that, when verification of the to-be-calibrated eyeball parameter is completed, in order to further complete calibration of a gaze point in the current gaze point scenario, the gaze calibration coordinates of the gaze point are determined based on the obtained position mapping relationship and the eyeball calibration parameter, and the gaze point can be calibrated based on the gaze calibration coordinates.

Specifically, in this embodiment, for step S30 in the embodiment provided in FIG. 1, the performing consistency check on the to-be-calibrated eyeball parameter based on the target eyeball parameter further includes:
determining a Hausdorff distance between ellipse images corresponding to the target eyeball parameter and the to-be-calibrated eyeball parameter based on the target eyeball parameter and the to-be-calibrated eyeball parameter; and
if the Hausdorff distance is less than a distance threshold, determining that the consistency check on the to-be-calibrated eyeball parameter is qualified.

Specifically, the Hausdorff distance is a distance between two subsets in a metric space, and can transform a non-empty subset of the metric space into the metric space. Therefore, in this embodiment, first, the Hausdorff distance between the ellipse images corresponding to the target eyeball parameter and the to-be-calibrated eyeball parameter is determined based on the target eyeball parameter and the to-be-calibrated eyeball parameter.

If the Hausdorff distance between the target eyeball parameter and the to-be-calibrated eyeball parameter is less than the distance threshold, which indicates that the deviation between the current to-be-calibrated eyeball parameter and the target eyeball parameter is extremely small, it can be accurately determined that the consistency check on the current to-be-calibrated eyeball parameter is qualified. Optionally, the distance threshold can be set as required. For example, the distance threshold can be set to 1.5, 1.8, 2, or 2.2.

Optionally, in this embodiment, after the to-be-calibrated eyeball parameter is calibrated based on the eyeball calibration parameters in step S40, the method further includes:
determining gaze calibration coordinates of a gaze point in the current gaze point scenario based on the position mapping relationship and the eyeball calibration parameter, and calibrating the gaze point based on the gaze calibration coordinates, where
the position mapping relationship between the calibrated gaze point and each eyeball position parameter is as follows:

$$\{ \begin{matrix}{x}_{g} = {f}_{x} ( {x}_{0} , {y}_{0} ) \\ {y}_{g} = {f}_{y} ( {x}_{0} , {y}_{0} )\end{matrix} .$$

In this step, the gaze point coordinates in the current gaze point scenario are determined based on the position mapping relationship and the eyeball calibration parameter, to obtain the gaze calibration coordinates. For example, when the center coordinates of the obtained eyeball calibration parameter are (x2, y2), the gaze calibration coordinates of the calibrated gaze point in the current gaze point scenario are (x_{g1}, y_{g1}), where x_{g1}=fₓ(x2, y2), and y_{g1}=f_{y}(x2, y2). In this step, the gaze point is calibrated based on the gaze calibration coordinates (x_{g1}, y_{g1}), thereby effectively improving accuracy of the gaze point coordinates in the current gaze point scenario.

It should be noted that the foregoing implementation process is only for illustrating enforceability of this application, but this does not mean that the eyeball parameter calibration method in this application has the only one implementation process described above. On the contrary, any process that can implement the eyeball parameter calibration method in this application can be included in feasible implementations of this application.

In conclusion, in the eyeball parameter calibration method in the foregoing embodiment of the present invention, the eyeball shape parameter of the to-be-calibrated eyeball parameter is determined based on the position mapping relationship. Further, the first similarity corresponding to the eyeball shape parameter and the eyeball position parameter in the target eyeball parameter is determined, and the second similarity corresponding to the eyeball shape parameter and the eyeball position parameter in the to-be-calibrated eyeball parameter is determined. Finally, whether the consistency between the to-be-calibrated eyeball parameter and the target eyeball parameter is qualified can be determined by determining whether the first similarity and the second similarity are both greater than the corresponding similarity threshold. A checking procedure is simple and checking efficiency is high.

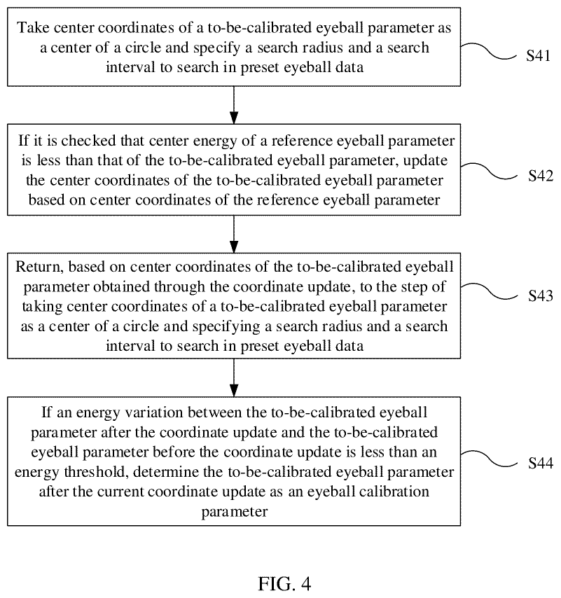

FIG. 4 shows an eyeball parameter calibration method according to a third embodiment of the present invention. This embodiment is for further detailing step S40 in the embodiment of FIG. 1, including the following steps.

Step S41: Take center coordinates of the to-be-calibrated eyeball parameter as a center of a circle and specify a search radius and a search interval to search in the preset eyeball data.

Specifically, in this step, it should be noted that, when the consistency between the to-be-calibrated eyeball parameter and the target eyeball parameter is good or the Hausdorff distance (Hausdorff distance) is small, further, an ellipse corresponding to an adjacent eyeball calculated by using the shape mapping relationship is used to search for an ellipse that best matches an image as a check result.

More specifically, the center coordinates of the to-be-calibrated eyeball parameter are taken as the center of the circle and the search radius and the search interval are specified to search in the preset eyeball data, that is, (\hat{x}₀, ŷ₀) is searched for around (\tilde{x}₀, \tilde{y}₀) (the search is solving by using a specific optimization algorithm, where an interval can be violently traversed; or the search can be iterative, and a search direction and a step size are guided based on a gradient). ê=(\hat{x}₀, ŷ₀, â, \hat{b}, \hat{θ}) is obtained based on the shape mapping relationship, so that the ellipse energy E(ê) is minimum (in a solving process, energy corresponding to each possible solution is evaluated, where if traverse is performed, an ellipse with minimum energy is selected; and if the search is iterative, an ellipse is selected when a stop condition is reached).

$$\hat{e} = arg {min}_{e} E ( e )$$

For example:

$$E ( e ) ≡ {E}_{I} ( e ) + {E}_{GM} ( e ) + {E}_{GD} ( e ) .$$

E_{I}(e) is brightness energy, E_{GM}(e) is gradient amplitude energy, and E_{GD}(e) is gradient direction energy.

The brightness energy can be defined as an image brightness value at a point on the ellipse corresponding to the eyeball parameter.

The gradient amplitude energy can be defined as an inverse of an image gradient amplitude at a point on the ellipse corresponding to the eyeball parameter.

The gradient direction energy can be defined as an included angle between a normal direction of a point on the ellipse corresponding to the eyeball parameter and an image gradient direction of the point.

The center coordinates of the to-be-calibrated eyeball parameter are taken as the center of the circle, that is, (\tilde{x}₀, \tilde{y}₀) is used as the center, the search radius Δ is specified, and a quantity of coordinates are specified at a sampling interval δ in a rectangular area determined by an upper left corner (\tilde{x}₀−Δ, \tilde{y}₀−Δ) and a lower right corner (\tilde{x}₀+Δ, \tilde{y}₀+Δ), to evaluate center energy at each coordinate. The center energy is a sum of the brightness energy, the gradient amplitude energy, and the gradient direction energy of the reference eyeball parameter.

Step S42: If it is checked that center energy of the reference eyeball parameter is less than that of the to-be-calibrated eyeball parameter, perform coordinate update on the center coordinates of the to-be-calibrated eyeball parameter based on center coordinates of the reference eyeball parameter.

In this step, if it is checked that the center energy of the reference eyeball parameter is less than that of the to-be-calibrated eyeball parameter, center coordinates of a reference eyeball parameter with minimum energy are used to update (\tilde{x}₀, \tilde{y}₀), and a search radius and a sampling interval are reduced to continue a next time of search, so that the center coordinates of the to-be-calibrated eyeball parameter can be updated based on the searched center coordinates of the reference eyeball parameter.

Step S43: Return, based on the center coordinates of the to-be-calibrated eyeball parameter obtained through the coordinate update, to the step of taking center coordinates of the to-be-calibrated eyeball parameter as a center of a circle and specifying a search radius and a search interval to search in the preset eyeball data.

Further, in this step, after the coordinate update of the center coordinates of the to-be-calibrated eyeball parameter is completed once, the step of taking center coordinates of the to-be-calibrated eyeball parameter as a center of a circle and specifying a search radius and a search interval to search in the preset eyeball data is returned based on center coordinates of the to-be-calibrated eyeball parameter obtained through the coordinate update, so as to perform a next time of search.

Step S44: If an energy variation between the to-be-calibrated eyeball parameter after the coordinate update and the to-be-calibrated eyeball parameter before the coordinate update is less than an energy threshold, determine the to-be-calibrated eyeball parameter after the current coordinate update as the eyeball calibration parameter.

Furthermore, if the energy variation between the to-be-calibrated eyeball parameter after the coordinate update and the to-be-calibrated eyeball parameter before the coordinate update is less than the energy threshold, the to-be-calibrated eyeball parameter after the current coordinate update is determined as the eyeball calibration parameter. The energy threshold can be set as required, and the energy threshold is for determining whether the search for the to-be-calibrated eyeball parameter converges. To be specific, when (\tilde{x}₀, \tilde{y}₀) or a variation of the minimum center energy is less than a specified threshold ∈, it is determined that the search for the to-be-calibrated eyeball parameter after the current coordinate update converges, and the to-be-calibrated eyeball parameter after the current coordinate update is determined as the eyeball calibration parameter.

In addition, optionally, in this embodiment, for step S40 in the embodiment provided in FIG. 1, the performing pattern matching on the to-be-calibrated eyeball parameter and the preset eyeball data to obtain an eyeball calibration parameter further includes:
setting an initial value of the to-be-calibrated eyeball parameter, and obtaining a corresponding energy function based on the initial value, where the initial value is an eyeball shape parameter and an eyeball position parameter of the pupil projection corresponding to the user's eyeball in the current gaze point scenario;
calculating, based on the energy function, a gradient corresponding to center coordinates of the to-be-calibrated eyeball parameter, and calculating a search direction; and
obtaining an optimal step size based on the energy function, and updating the center coordinates of the to-be-calibrated eyeball parameter, to obtain the eyeball calibration parameter.

Specifically, in this step, it should be noted that, first, the initial value of the to-be-calibrated eyeball parameter c⁽⁰⁾ is set to (\tilde{x}₀, \tilde{y}₀), an allowed error is ∈, and H₀⁻¹ and t=0 are set, where t is an iteration quantity, and Hₜ⁻¹ approximates an inverse of a second derivative matrix of a multivariate function.

Then, the energy function e^{(t)}=fₑ(c^{(t)}) is obtained based on

$$\{ \begin{matrix}a = {f}_{a} ( {x}_{0} , {y}_{0} ) \\ b = {f}_{b} ( {x}_{0} , {y}_{0} ) \\ θ = {f}_{θ} ( {x}_{0} , {y}_{0} )\end{matrix} .$$

The energy function E(e^{(t)}) is calculated.

The gradient gₜ of the energy function E(e^{(t)}) about (x₀, y₀) is calculated.

The search direction d^{(t)}=−Hₜ⁻¹·gₜ is calculated.

Search is performed starting from c^{(t)} and along d^{(t)}, to obtain the optimal step size and perform parameter update.

$${λ}_{t} = {arg min}_{α} E ( {f}_{e} ( {c}^{( t )} + λ \cdot {d}^{( t )} ) )$$

$${c}^{( t + 1 )} = {c}^{( t )} + {λ}_{t} \cdot {d}^{( t )}$$

If |gₜ₊₁|<ϵ, iteration is stopped.

If |gₜ₊₁|≥ϵ, Δgₜ=gₜ₊₁−gₜ and Δcₜ=c^{(t+1)}−c^{(t)} are calculated, and H⁻¹ is updated.

$${H}_{t + 1}^{- 1} = ( {I}_{2} - \frac{Δ {c}_{t} Δ {g}_{t}^{T}}{Δ {c}_{t}^{T} Δ {g}_{t}} ) {B}_{t}^{- 1} ( {I}_{2} - \frac{Δ {g}_{t} Δ {c}_{t}^{T}}{Δ {c}_{t}^{T} Δ {g}_{t}} ) + \frac{Δ {c}_{t} Δ {c}_{t}^{T}}{Δ {c}_{t}^{T} Δ {g}_{t}}$$

t=t+1, so that the eyeball calibration parameter can be obtained.

In conclusion, in the eyeball parameter calibration method in the foregoing embodiment of the present invention, the center coordinates of the to-be-calibrated eyeball parameter are taken as the center of the circle and the search radius and the search interval are specified to search in the preset eyeball data. Further, if it is checked that the center energy of the reference eyeball parameter is less than that of the to-be-calibrated eyeball parameter, the center coordinates of the to-be-calibrated eyeball parameter are updated based on the center coordinates of the reference eyeball parameter. In this way, the update of the center coordinates of the to-be-calibrated eyeball parameter can be preliminarily completed. Further, the step of taking the center coordinates of the to-be-calibrated eyeball parameter as the center of the circle and specifying the search radius and the search interval to search in the preset eyeball data is returned based on the center coordinates of the to-be-calibrated eyeball parameter after the coordinate update, so that a checking range can be greatly reduced, and update accuracy of the center coordinates of the to-be-calibrated eyeball parameter can be improved. The to-be-calibrated eyeball parameter after the current coordinate update can be determined as the eyeball calibration parameter, until the energy variation between the to-be-calibrated eyeball parameter after the coordinate update and the to-be-calibrated eyeball parameter before the coordinate update is less than the energy threshold.

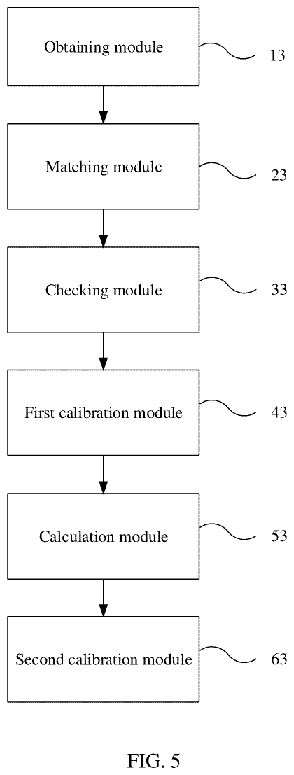

FIG. 5 shows an eyeball parameter calibration system according to a fourth embodiment of the present invention. The system includes:
an obtaining module 13, configured to obtain an image parameter of a pupil projection corresponding to an eyeball of a user in a current gaze point scenario, to obtain a to-be-calibrated eyeball parameter;
a matching module 23, configured to perform coordinate matching on the to-be-calibrated eyeball parameter and preset eyeball data to obtain a target eyeball parameter, where the preset eyeball data includes image parameters of the pupil projection corresponding to the eyeball of the user in different gaze point scenarios;
a checking module 33, configured to perform consistency check on the to-be-calibrated eyeball parameter based on the target eyeball parameter; and
a first calibration module 43, configured to: if the consistency check on the to-be-calibrated eyeball parameter is qualified, perform pattern matching on the to-be-calibrated eyeball parameter and the preset eyeball data to obtain an eyeball calibration parameter, and calibrate the to-be-calibrated eyeball parameter based on the eyeball calibration parameter.

In the eyeball parameter calibration system, the system further includes a calculation module 53. The calculation module 53 is specifically configured to:
obtain image parameters of the pupil projection corresponding to the eyeball of the user in different gaze point scenarios based on a preset eyeball model, to obtain at least one reference eyeball parameter, where the reference eyeball parameter includes an eyeball shape parameter and an eyeball position parameter;
determine a position mapping relationship between a calibrated gaze point and each eyeball position parameter based on gaze point coordinates of the calibrated gaze point and each eyeball position parameter; and
determine a shape mapping relationship based on the eyeball shape parameter and the eyeball position parameter in each reference eyeball parameter.

In the eyeball parameter calibration system, the checking module 33 includes a first checking unit. The first checking unit is specifically configured to:
determine an eyeball shape parameter of the to-be-calibrated eyeball parameter based on the shape mapping relationship;
respectively determine similarities between an eyeball shape parameter and an eyeball position parameter of the target eyeball parameter and those of the to-be-calibrated eyeball parameter to obtain a first similarity and a second similarity; and
if the first similarity and the second similarity are both greater than a corresponding similarity threshold, determine that the consistency check on the to-be-calibrated eyeball parameter is qualified.

In the eyeball parameter calibration system, the checking module 33 includes a second checking unit. The second checking unit is specifically configured to:
determine a Hausdorff distance between ellipse images corresponding to the target eyeball parameter and the to-be-calibrated eyeball parameter based on the target eyeball parameter and the to-be-calibrated eyeball parameter; and
if the Hausdorff distance is less than a distance threshold, determine that the consistency check on the to-be-calibrated eyeball parameter is qualified.

In the eyeball parameter calibration system, the matching module 23 includes a first matching unit. The first matching unit is specifically configured to:
take center coordinates of the to-be-calibrated eyeball parameter as a center of a circle and specify a search radius and a search interval to search in the preset eyeball data;
if it is checked that center energy of the reference eyeball parameter is less than that of the to-be-calibrated eyeball parameter, perform coordinate update on the center coordinates of the to-be-calibrated eyeball parameter based on center coordinates of the reference eyeball parameter, where the center energy is a sum of brightness energy, gradient amplitude energy and gradient direction energy of the reference eyeball parameter;
return, based on center coordinates of the to-be-calibrated eyeball parameter obtained through the coordinate update, to the step of taking center coordinates of the to-be-calibrated eyeball parameter as a center of a circle and specifying a search radius and a search interval to search in the preset eyeball data; and
if an energy variation between the to-be-calibrated eyeball parameter after the coordinate update and the to-be-calibrated eyeball parameter before the coordinate update is less than an energy threshold, determine the to-be-calibrated eyeball parameter after the current coordinate update as the eyeball calibration parameter.

In the eyeball parameter calibration system, the matching module 23 includes a second matching unit. The second matching unit is specifically configured to:
set an initial value of the to-be-calibrated eyeball parameter, and obtain a corresponding energy function based on the initial value;
calculate, based on the energy function, a gradient corresponding to center coordinates of the to-be-calibrated eyeball parameter, and calculate a search direction; and
obtain an optimal step size based on the energy function, and update the center coordinates of the to-be-calibrated eyeball parameter, to obtain the eyeball calibration parameter.

In the eyeball parameter calibration system, the system further includes a second calibration module 63. The second calibration module 63 is specifically configured to:
determine gaze calibration coordinates of a gaze point in the current gaze point scenario based on the position mapping relationship and the eyeball calibration parameter, and calibrate the gaze point based on the gaze calibration coordinates.

A fifth embodiment of the present invention provides a computer including a memory, a processor, and a computer program stored in the memory and capable of running on the processor, where when the processor executes the computer program, the eyeball parameter calibration method provided in the first embodiment, the second embodiment, or the third embodiment is implemented.

A sixth embodiment of the present invention provides a readable storage medium, storing a computer program, where when the program is executed by a processor, the eyeball parameter calibration method provided in the first embodiment, the second embodiment, or the third embodiment is implemented.

In conclusion, in the eyeball parameter calibration method and system, the computer, and the readable storage medium in the foregoing embodiments of the present invention, the to-be-calibrated eyeball parameter is obtained by obtaining the image parameter of the pupil projection corresponding to the eyeball of the user, so that a check result of an ellipse corresponding to a pupil of the eyeball of the user can be preliminarily obtained. Further, coordinate matching is performed on the to-be-calibrated eyeball parameter and the preset eyeball data to obtain the corresponding target eyeball parameter in the current gaze point scenario. Then, the consistency check is performed on the to-be-calibrated eyeball parameter and the target eyeball parameter, to check a parameter error between the to-be-calibrated eyeball parameter and the target eyeball parameter. Whether the to-be-calibrated eyeball parameter is a valid parameter can be effectively checked depending on the parameter error. If the consistency check on the to-be-calibrated eyeball parameter is qualified, it is determined that pattern matching is performed on the to-be-calibrated eyeball parameter and the preset eyeball data to determine the eyeball calibration parameter of the to-be-calibrated eyeball parameter in the preset eyeball data. The to-be-calibrated eyeball parameter is calibrated based on the eyeball calibration parameter, so that the to-be-calibrated eyeball parameter can be effectively corrected, thereby avoiding errors and improving user experience.

The logic and/or steps illustrated in the flowchart or described in other ways herein, for example, can be regarded as a sequenced list of executable instructions for implementing logical functions, and can be specifically embodied in any computer-readable medium for use by or use in combination with an instruction execution system, apparatus or device (such as a computer-based system, a system including a processor or other systems that can extract instructions from the instruction execution system, apparatus, or device and execute the instructions). In this specification, the “computer-readable medium” may be any apparatus that may include, store, communicate, transmit, or transfer a program, for use by or use in combination with an instruction execution system, apparatus, or device.

More specific examples (non-exhaustive list) of the computer-readable medium include the following: an electrical connection part (electronic apparatus) having one or more wires, a portable computer tray (magnetic apparatus), a random access memory (RAM), a read-only memory (ROM), an erasable programmable read-only memory (EPROM or flash memory), an optical fiber apparatus, and a portable compact disk read-only memory (CD-ROM). In addition, the computer-readable medium may even be paper or another suitable medium on which the program can be printed, because the program can be obtained electronically by, for example, optically scanning the paper or the another medium, followed by editing, interpreting or processing in other suitable ways if necessary, and then stored in a computer memory.

It should be understood that various parts of the present invention can be implemented in hardware, software, firmware or a combination thereof. In the foregoing implementations, a plurality of steps or methods can be implemented by software or firmware stored in a memory and executed by an appropriate instruction execution system. For example, if hardware is for implementation, as in another embodiment, any one of the following technologies or a combination thereof can be used for implementation: a discrete logic circuit with a logic gate for implementing a logic function on a data signal, an application-specific integrated circuit with a suitable combinational logic gate circuit, a programmable gate array (PGA), a field-programmable gate array (FPGA), and the like.

In the descriptions of this specification, descriptions of reference terms such as “one embodiment”, “some embodiments”, “example”, “specific example”, or “some examples” mean that specific features, structures, materials or characteristics described with reference to embodiments or examples are included in at least one embodiment or example of the present invention. In this specification, schematic expressions of the foregoing terms do not necessarily refer to a same embodiment or example. Moreover, the specific features, structures, materials or characteristics described may be combined in any one or more embodiments or examples in a suitable manner.

The foregoing embodiments only illustrate several implementations of the present invention, and their descriptions are more specific and detailed, but cannot be understood as limiting the patent scope of the present invention. It should be pointed out that for those of ordinary skilled in the art, without departing from the concept of the present invention, several variations and improvements can be made. These fall within the protection scope of the present invention. Therefore, the protection scope of the present invention shall be subject to the claims.

What is claimed is:

1. An eyeball parameter calibration method, wherein the method comprises:
obtaining an image parameter of a pupil projection corresponding to an eyeball of a user in a current gaze point scenario, to obtain a to-be-calibrated eyeball parameter;
performing coordinate matching on the to-be-calibrated eyeball parameter and preset eyeball data to obtain a target eyeball parameter, wherein the preset eyeball data comprises image parameters of the pupil projection corresponding to the eyeball of the user in different gaze point scenarios;
performing consistency check on the to-be-calibrated eyeball parameter based on the target eyeball parameter; and
if the consistency check on the to-be-calibrated eyeball parameter is qualified, performing pattern matching on the to-be-calibrated eyeball parameter and the preset eyeball data to obtain an eyeball calibration parameter, and calibrating the to-be-calibrated eyeball parameter based on the eyeball calibration parameter.

2. The eyeball parameter calibration method according to claim 1, wherein the method further comprises:
obtaining image parameters of the pupil projection corresponding to the eyeball of the user in different gaze point scenarios based on a preset eyeball model, to obtain at least one reference eyeball parameter, wherein the reference eyeball parameter comprises an eyeball shape parameter and an eyeball position parameter;
determining a position mapping relationship between a calibrated gaze point and each eyeball position parameter based on gaze point coordinates of the calibrated gaze point and each eyeball position parameter; and
determining a shape mapping relationship based on the eyeball shape parameter and the eyeball position parameter in each reference eyeball parameter.

3. The eyeball parameter calibration method according to claim 2, wherein the step of performing consistency check on the to-be-calibrated eyeball parameter based on the target eyeball parameter comprises:
determining an eyeball shape parameter of the to-be-calibrated eyeball parameter based on the shape mapping relationship;
respectively determining similarities between an eyeball shape parameter and an eyeball position parameter of the target eyeball parameter and those of the to-be-calibrated eyeball parameter to obtain a first similarity and a second similarity; and
if the first similarity and the second similarity are both greater than a corresponding similarity threshold, determining that the consistency check on the to-be-calibrated eyeball parameter is qualified.

4. The eyeball parameter calibration method according to claim 1, wherein the step of performing consistency check on the to-be-calibrated eyeball parameter based on the target eyeball parameter further comprises:
determining a Hausdorff distance between ellipse images corresponding to the target eyeball parameter and the to-be-calibrated eyeball parameter based on the target eyeball parameter and the to-be-calibrated eyeball parameter; and
if the Hausdorff distance is less than a distance threshold, determining that the consistency check on the to-be-calibrated eyeball parameter is qualified.

5. The eyeball parameter calibration method according to claim 2, wherein the step of performing pattern matching on the to-be-calibrated eyeball parameter and the preset eyeball data to obtain an eyeball calibration parameter comprises:
taking center coordinates of the to-be-calibrated eyeball parameter as a center of a circle and specifying a search radius and a search interval to search in the preset eyeball data;
if it is checked that center energy of any one of the at least one reference eyeball parameter is less than that of the to-be-calibrated eyeball parameter, performing coordinate update on the center coordinates of the to-be-calibrated eyeball parameter based on center coordinates of the reference eyeball parameter, wherein the center energy is a sum of brightness energy, gradient amplitude energy and gradient direction energy of a corresponding eyeball parameter;
returning, based on center coordinates of the to-be-calibrated eyeball parameter obtained through the coordinate update, to the step of taking center coordinates of the to-be-calibrated eyeball parameter as a center of a circle and specifying a search radius and a search interval to search in the preset eyeball data; and
if an energy variation between the to-be-calibrated eyeball parameter after the coordinate update and the to-be-calibrated eyeball parameter before the coordinate update is less than an energy threshold, determining the to-be-calibrated eyeball parameter after the current coordinate update as the eyeball calibration parameter.

6. The eyeball parameter calibration method according to claim 1, wherein the step of performing pattern matching on the to-be-calibrated eyeball parameter and the preset eyeball data to obtain an eyeball calibration parameter further comprises:
setting an initial value of the to-be-calibrated eyeball parameter, and obtaining a corresponding energy function based on the initial value;
calculating, based on the energy function, a gradient corresponding to center coordinates of the to-be-calibrated eyeball parameter, and calculating a search direction; and
obtaining an optimal step size based on the energy function, and updating the center coordinates of the to-be-calibrated eyeball parameter, to obtain the eyeball calibration parameter.

7. The eyeball parameter calibration method according to claim 3, wherein after the step of calibrating the to-be-calibrated eyeball parameter based on the eyeball calibration parameter, the method further comprises:
determining gaze calibration coordinates of a gaze point in the current gaze point scenario based on the position mapping relationship and the eyeball calibration parameter, and calibrating the gaze point based on the gaze calibration coordinates.

8. An eyeball parameter calibration system, wherein the system comprises:
an obtaining module, configured to obtain an image parameter of a pupil projection corresponding to an eyeball of a user in a current gaze point scenario, to obtain a to-be-calibrated eyeball parameter;
a matching module, configured to perform coordinate matching on the to-be-calibrated eyeball parameter and preset eyeball data to obtain a target eyeball parameter, wherein the preset eyeball data comprises image parameters of the pupil projection corresponding to the eyeball of the user in different gaze point scenarios;
a checking module, configured to perform consistency check on the to-be-calibrated eyeball parameter based on the target eyeball parameter; and
a first calibration module, configured to: if the consistency check on the to-be-calibrated eyeball parameter is qualified, perform pattern matching on the to-be-calibrated eyeball parameter and the preset eyeball data to obtain an eyeball calibration parameter, and calibrate the to-be-calibrated eyeball parameter based on the eyeball calibration parameter.

9. A computer, comprising a memory, a processor, and a computer program stored in the memory and capable of being run on the processor, wherein when the processor executes the computer program, the eyeball parameter calibration method according to any one of claims 1 to 7 is implemented.

10. A readable storage medium, storing a computer program, wherein when the program is executed by a processor, the eyeball parameter calibration method according to any one of claims 1 to 7 is implemented.
